(19) United States
(12) Patent Application Publication
(10) Pub. No.: US 2011/0017768 A1
(43) Pub. Date: Jan. 27, 2011

(54) VERTICAL SMALL PACKET DISPENSER

(76) Inventor: Antonio VARDARO, Montreal (CA)

Correspondence Address: LADAS & PARRY LLP, 224 SOUTH MICHIGAN AVENUE, SUITE 1600, CHICAGO, IL, 60604, US

(21) Appl. No.: 12/839,901

(22) Filed: Jul. 20, 2010

Related U.S. Application Data
(60) Provisional application No. 61/213,827, filed on Jul. 20, 2009.
(60) Provisional application No. 61/213,828, filed on Jul. 20, 2009.

(51) Int. Cl. B65D 83/00; B65H 1/28; B65G 59/02

(52) U.S. Cl. 221/131; 221/279; 221/282

(57) ABSTRACT

A dispenser for packets comprising a housing defining a channel, an outlet opening in communication with the channel and a platform movably mounted to the housing through the outlet opening. The channel provides for receiving a vertical stack of packets. The platform comprises lower and upper level portions thereof and is movable between an outward position and an inward position. In the outward position, the lower level portion is positioned outwardly of the housing and the upper level portion is positioned in the channel. In the inward position, the lower and upper level portions are positioned in the channel. When the platform is in the outward position, the vertical stack rests on the upper level portion. When the platform is moved to the inward position, the vertical stack drops on the lower level portion and when the platform is returned to the outward position, the lower level portion moves the lowermost packet of the vertical stack outwardly of the housing therewith through the outlet opening.

### CROSS-REFERENCE TO RELATED APPLICATIONS

The present application claims priority on U.S. Provisional Patent Application No. 61/213,828 filed on Jul. 20, 2009 and on U.S. Provisional Patent Application No. 61/213,827 filed on Jul. 20, 2009 which are incorporated herein in their entirety.

### TECHNICAL FIELD

The present disclosure relates to a dispenser. More specifically but not exclusively, the disclosure relates to a vertical small packet dispenser. More particularly but not exclusively, the disclosure relates to a cigarette dispenser.

### BACKGROUND

The art teaches a variety of small packet or cigarette dispensers.

Known cigarette dispensers include a cabinet with vertical columns for stacking packs of cigarettes. The user may pull out packs of cigarettes directly from bottom slanted cut outs. A camming piece pushes the lowermost package of the stack rearwardly thus the bottom package of each vertical stack projects to the rear allowing the package to be extracted via the cut out. The packages directly above the lowermost package do not follow the latter to the rear, since when the lowermost package is caromed to the rear, the second package from the bottom is restrained by a blocking bar. Once the lowermost package is removed then space is provide for the next package to take its place.

Some dispensers also provide for displaying advertisements. For example, the art teaches purchase gravity feed package product dispensers with a bottom opening to manually pull out a package. The dispensers include panels which are replaceable in order to display a variety of advertisements. The art also teaches a dispenser having bottom feed outlets with packs that are vertically stacked to be manually removed from openings. This dispenser includes a removable display sleeve for advertisements.

Drawbacks of known dispensers is that the number of vertical columns cannot be modified, the size of the vertical columns cannot be modified, the front face of the dispenser cannot be enlarged or reduced thereby providing different front face for differently sized advertisement displays or other displays or structures therefore.

### OBJECTS

An object of the disclosure is to provide a vertical small packet dispenser.

An object of the disclosure is to provide a vertical cigarette dispenser.

An object of the disclosure is to provide a vertical dispenser and cabinet assembly.

An object of the disclosure is to provide a vertical dispenser column for a vertical dispenser assembly.

### SUMMARY OF THE EMBODIMENTS

In accordance with an embodiment, there is provided a dispenser for packets comprising:

a housing defining a channel for receiving a vertical stack of packets and having an outlet opening in communication with the channel; and

a platform comprising lower and upper level portions thereof and being movably mounted to the housing through the outlet opening so as to be movable between an outward position, wherein the lower level portion is positioned outwardly of the housing and the upper level portion is positioned in the channel, and an inward position, wherein the lower and upper level portions are positioned in the channel,

wherein when the platform is in the outward position, the vertical stack rests on the upper level portion, when the platform is moved to the inward position, the vertical stack drops on the lower level portion and when the platform is returned to the outward position, the lower level portion moves the lowermost packet of the vertical stack outwardly of the housing therewith through the outlet opening.

In accordance with an embodiment, there is provided a dispenser comprising:

a housing defining a vertical channel defining a vertical receiving area thereof for receiving a vertical stack of similar sized packets and having an outlet opening in communication with the channel; and

a vertical adjustment member movably mounted to the housing within the channel for adjusting the size of the receiving area,

wherein the size of the receiving area is adjusted in accordance with the size of the packets in the vertical stack.

In accordance with an embodiment, there is provided a dispenser comprising

a housing comprising:

at least two wall members defining a vertical channel for receiving a vertical stack of packets therein; and

an outlet opening in communication with the channel,

wherein at least one of the wall members is movable so as to modify the width of the channel.

In accordance with an embodiment, there is provided a dispenser assembly comprising:

a plurality of separate side by side vertical dispenser columns defining a common front face comprising mounting elements thereof for receiving a display, each vertical dispenser column defining a vertical channel for receiving a vertical stack of packets therein and an outlet opening communication with the channel,

wherein the width of the front face is modifiable by adding or removing one or more of the vertical dispenser columns in accordance with the width of the display.

Various dispenser assemblies comprising the present dispensers are also provided.

In accordance with an embodiment, there is provided a vertical column dispenser for a dispenser assembly comprising: a housing defining a channel for receiving a vertical stack of small packets therein; an outlet formed near the bottom of the housing for dispensing a packet; and a movable platform mounted to the housing via the outlet and comprising upper and lower platform portions, the movable platform being movable between outward and inward positions relative the housing, wherein when in the outward position the vertical stack rests on the upper platform portion, when the movable platform is moved inwardly, the vertical stack drops on the lower platform portion and when the movable platform is returned to the outward position, the lower platform moves the lower most packet of the vertical stack outwardly therewith.

In accordance with an embodiment, there is provided a vertical dispenser assembly having a front face for receiving a display thereon, the dispenser assembly comprising: a plurality of separate side by side vertical dispenser columns defining a channel for receiving a vertical stack of small packets therein, each dispenser column having a respective bottom outlet for dispensing a packet, the side by side vertical columns defining the front face of the dispenser assembly, wherein the width of the front face of the dispenser assembly is modifiable by adding or removing vertical dispenser columns.

In accordance with an embodiment, there is provided a vertical dispenser assembly comprising: a plurality of separate side by side vertical dispenser columns, each vertical dispenser column comprising wall members defining a channel therebetween for receiving a vertical stack of small packets therein, each vertical dispenser column having a respective bottom outlet for dispensing a packet wherein at least one of the wall members of the vertical dispenser columns is movable so as to modify the width of the channel.

In accordance with an embodiment, there is provided a vertical dispenser column for a dispenser assembly comprising: wall members defining a channel therebetween for receiving a vertical stack of small packets therein; and a bottom outlet for dispensing a packet, wherein at least one of the wall members of the vertical dispenser columns is movable so as to modify the width of the channel.

In accordance with an embodiment, there is provided a vertical column dispenser for a dispenser assembly comprising: a housing defining a channel for receiving a vertical stack of small packets therein; an outlet formed near the bottom of the housing for dispensing a packet; and a movable adjustment member mounted within the housing for adjusting the size of the channel.

In accordance with an aspect of the present invention there is provided a vertical dispenser and cabinet assembly comprising: a cabinet defining a countertop; a support mounted to the countertop; and a dispenser assembly mounted to the support, the dispenser assembly comprising a plurality of separate and side by side vertical dispenser columns, each vertical dispenser column defining a channel for receiving a stack of small packets therein, each vertical dispenser column having a bottom outlet for dispensing packets.

In an embodiment, a small packet dispenser assembly is provided and includes a plurality of separate side by side vertical dispenser columns which together define the front face of the dispenser assembly. The width of the front face can be modified by adding or removing vertical dispenser columns. A variety of displays can be mounted to the front face. Each vertical dispenser column includes walls defining a channel therebetween for receiving a vertical stack of small packets therein. Each vertical dispenser column has a respective bottom outlet for dispensing a packet. At least one of the wall members of the vertical dispenser columns is movable so as to modify the width of the channel. The dispenser assembly can be mounted to a cabinet or other structure. A movable platform positioned at the outlet for retrieving packets is also provided

Other objects, advantages and features of the present invention will become more apparent upon reading of the following non-restrictive description of non-limiting illustrative embodiments thereof, given by way of example only with reference to the accompanying drawings.

### BRIEF DESCRIPTION OF THE DRAWINGS

In the appended drawings, where like reference numerals denote like elements throughout and in where:

FIG. 1 is a perspective front view of a vertical dispenser assembly mounted to a cabinet in accordance with a non restrictive illustrative embodiment of the disclosure;

FIG. 2 is a rear perspective view of the vertical dispenser assembly of FIG. 1;

FIG. 3 is a perspective and partially exploded rear view of the vertical dispenser assembly mounted to a cabinet in accordance with a non-restrictive illustrative embodiment of the disclosure;

FIG. 4 is a front perspective partially exploded view of the vertical dispenser assembly mounted to a cabinet in accordance with a non-restrictive illustrative embodiment of the disclosure;

FIG. 5 is a perspective exploded view of the vertical dispenser column of the dispenser assembly in accordance with a non-restrictive illustrative embodiment of the disclosure;

FIG. 6 is a top perspective view of the vertical dispenser column mounted to a top rail in accordance with a non-restrictive illustrative embodiment of the disclosure;

FIGS. 7A, 7B and 7C are top plan views of the vertical dispenser column having different widths in accordance with a non-restrictive illustrative embodiment of the disclosure;

FIGS. 8A, 8B and 8C are bottom perspective front views of the vertical dispenser assembly of Figure with a non-restrictive illustrative embodiment of the disclosure;

FIG. 9 is a front perspective view of a vertical dispenser assembly mounted to a cabinet in accordance with another non-restrictive illustrative embodiment of the disclosure;

FIG. 10 is a front perspective view of a vertical dispenser assembly mounted to a cabinet in accordance with a further non-restrictive illustrative embodiment of the disclosure;

FIGS. 11 and 12 are front perspective views of a vertical dispenser assembly mounted to a cabinet in accordance with yet another non-restrictive illustrative embodiment of the disclosure;

FIG. 13 is a rear elevational view a vertical dispenser column in accordance with another non restrictive illustrative embodiment of the disclosure;

FIG. 14 is a rear perspective view of the vertical dispenser column of FIG. 9;

FIG. 15 is a side elevational view of the vertical dispenser column of FIG. 9;

FIG. 16 is an exploded perspective view of the vertical dispenser column of FIG. 9;

FIG. 17 is a perspective view of a vertical dispenser column in accordance with a further non-restrictive illustrative embodiment of the disclosure;

FIG. 18 is a front elevational view of the vertical dispenser column of FIG. 17;

FIG. 19 is a lateral elevational view of the vertical dispenser column of FIG. 17;

FIG. 20 is a perspective exploded view of the vertical dispenser column of FIG. 17; and

FIGS. 21, 22 and 23 are sectional lateral views of the vertical dispenser column of FIG. 17.

### DETAILED DESCRIPTION OF ILLUSTRATIVE EMBODIMENTS

Generally stated, in accordance with a non-exclusive illustrative embodiment, there is provided a vertical dispenser assembly that can be mounted to a countertop, a cabinet or that can be a stand-alone. The dispenser assembly includes a plurality of side by side separate vertical dispensing columns defining channels for vertically stacking small packets therein that can be dispensed via a bottom outlet thereof that acts as an out-feed. The outlet leads to a platform on which sits the lowermost packet of the stack. Once the lowermost packet is removed the next upper adjacent packet falls in its place. In another embodiment, the platform can be movable relative to the housing for being pushed inwardly and then being outwardly biased to exit with a packet for retrieval thereof. The width of the channels can be modified depending on the size of the packet. The side by side vertical dispenser columns provide the common front face of the dispensing assembly. The width of this common front face is modified by adding or removing vertical columns. The front face includes mounting elements for receiving various advertisement displays and the like.

With reference to the appended drawings, non-limiting illustrative embodiments will be described herein.

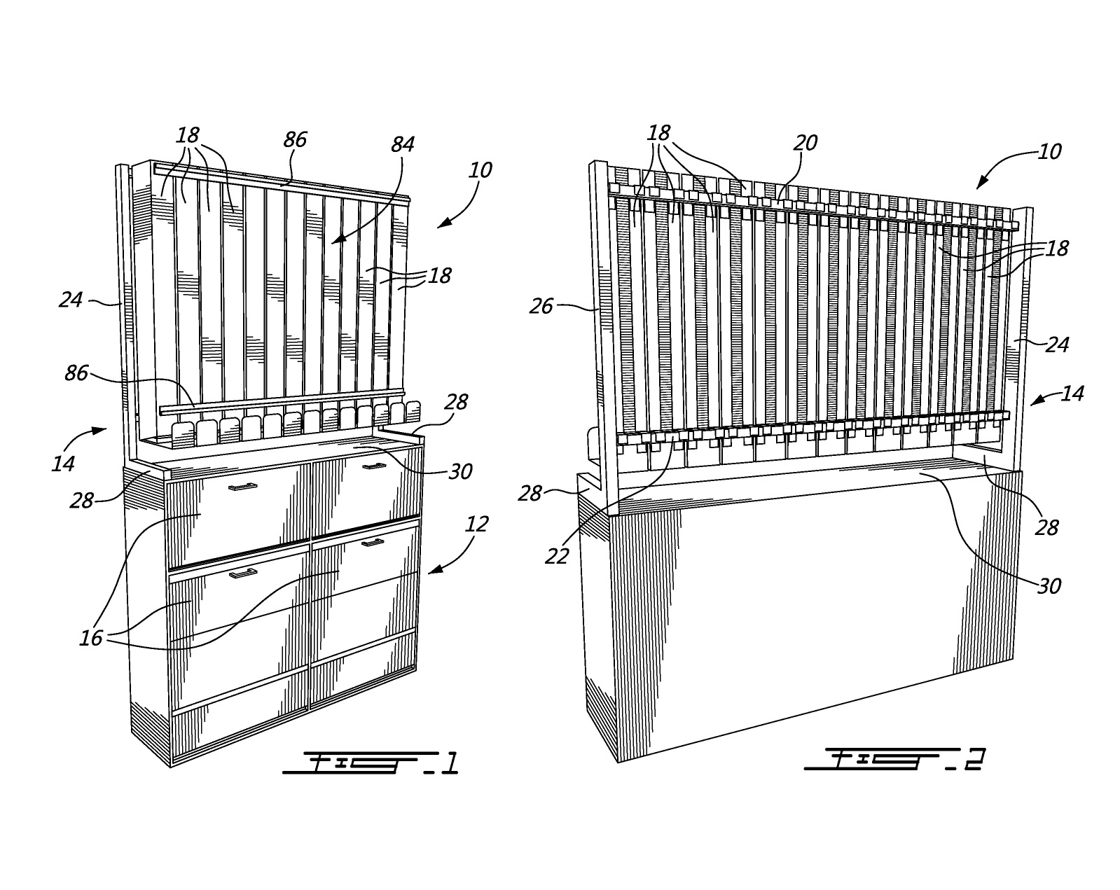

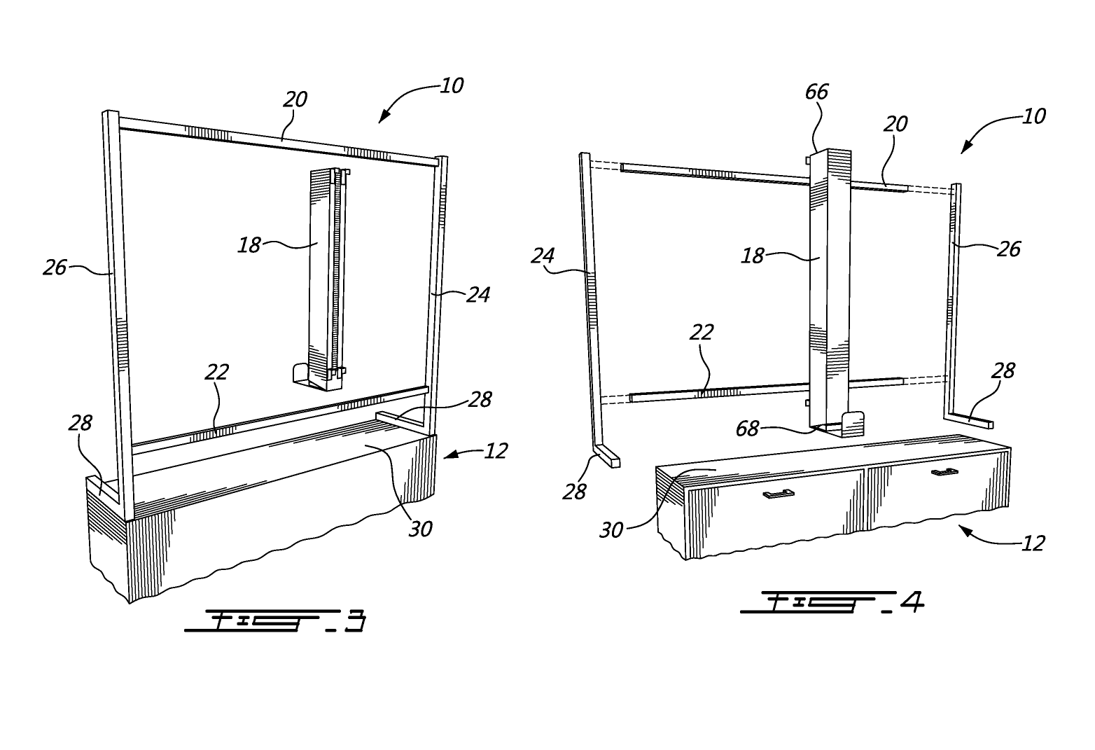

FIGS. 1 to 4 show a vertical dispenser assembly 10 mounted to a cabinet 12 thereby providing a vertical dispenser and cabinet assembly 14. The cabinet 12 can be provided in a variety of configurations with various doors 16 and drawers as is known in the art. Of course the present vertical dispenser assembly 10 can be mounted on a table, on a pair of longitudinal posts directly on the floor, on a shelf or a counter to give but a few non-limiting examples.

The vertical dispenser assembly 10 includes a plurality of side by side vertical dispenser columns 18 mounted to top 20 and bottom 22 rails which are in turn mounted to a pair of post members 24 and 26 having respective bases 28 mounted directly on the countertop 30 of the cabinet 12.

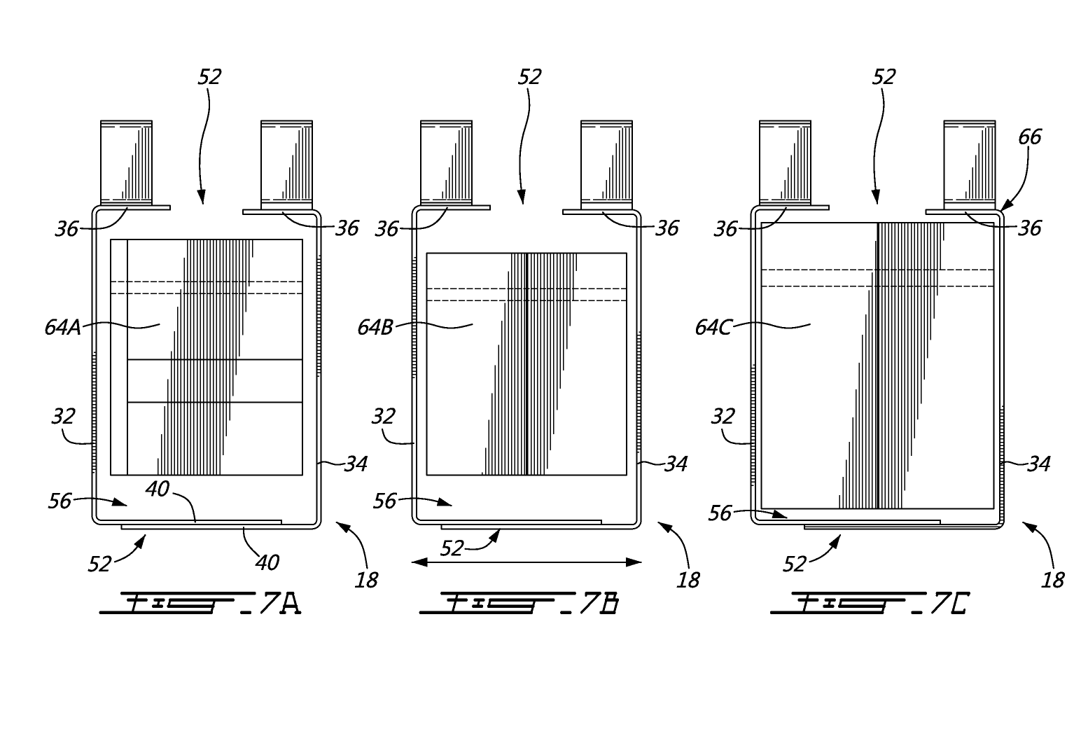

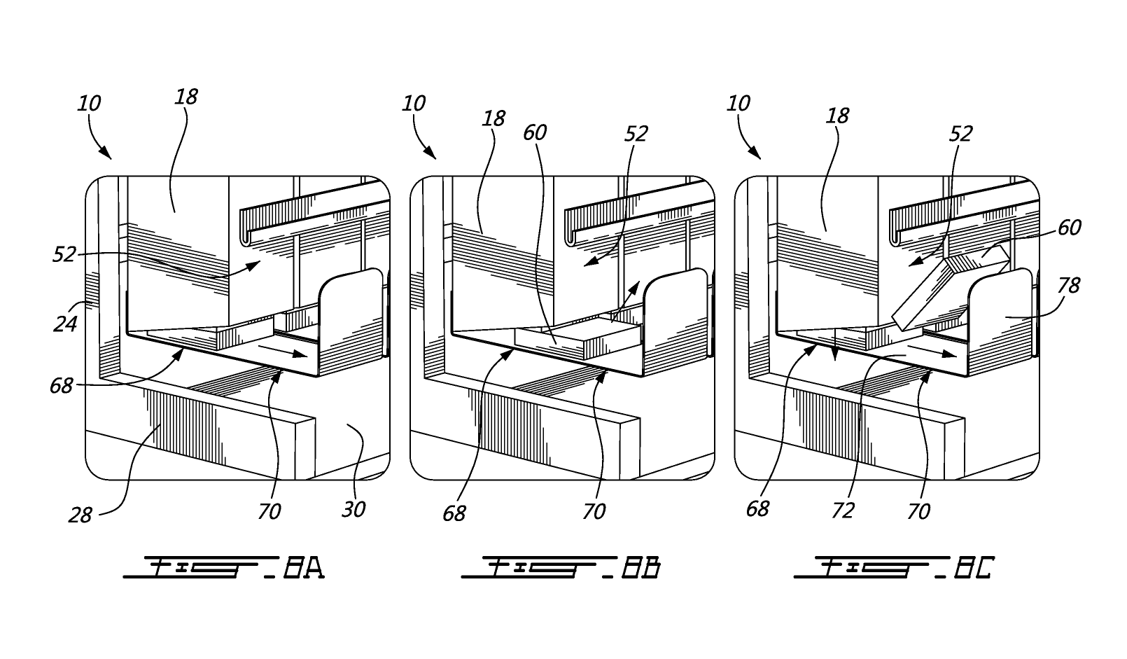

With respect to FIG. 5, a vertical dispenser column 18 comprises similar first 32 and second 34 longitudinal elements; each element 32 and 34 having a respective narrow back wall 36 (see FIGS. 7A-7C), a lateral wall 38, and a front wall 40 and an open lateral side 42. The longitudinal elements 32 and 34 are assembled via their open lateral sides 42. Moreover, each longitudinal element 32 and 34 includes respective top and bottom ends 44 and 46 having respective top hook elements 48 near their top end 44 and bottom hook elements 50 near their bottom end 46. Hook elements 44 and 46 protrude from the narrow back walls 36 of the longitudinal elements 32 and 34. As shown in FIG. 6, the top hook elements 48 are mounted to the top rail 20 whereas the bottom hook elements 50 are mounted to the bottom rail 22.

When the first and second longitudinal elements 32 and 34 are assembled, their respective front walls 40 overlap thereby defining a common front wall 52 (see FIGS. 6-8C) as well as a common rear slot 54 (see FIGS. 7A-7C) between the respective back walls 36. The assembled vertical dispenser column 18 provides a longitudinal channel 56 (see FIGS. 6-7C) for receiving a stack 58 (see FIGS. 5-6) of packets 60 such as cigarette packages for example. In one non-limiting example, the cigarette packages 60 can be provided within a support cage 62. With respect to FIGS. 7A. 7B and 7C, the overlapping front walls 40 provide for modifying the width of the common front wall 52 and the channel 56 by adjusting the distance between the first and second longitudinal elements 32 and 34 in accordance with the size of the packets. In the illustrated example, the width of the channel 56 is adjusted by moving the first and second longitudinal elements 32 and 34 closer or further away from one another so as to fit packets 64A, 64B and 64C having a small, a medium and a large size respectively.

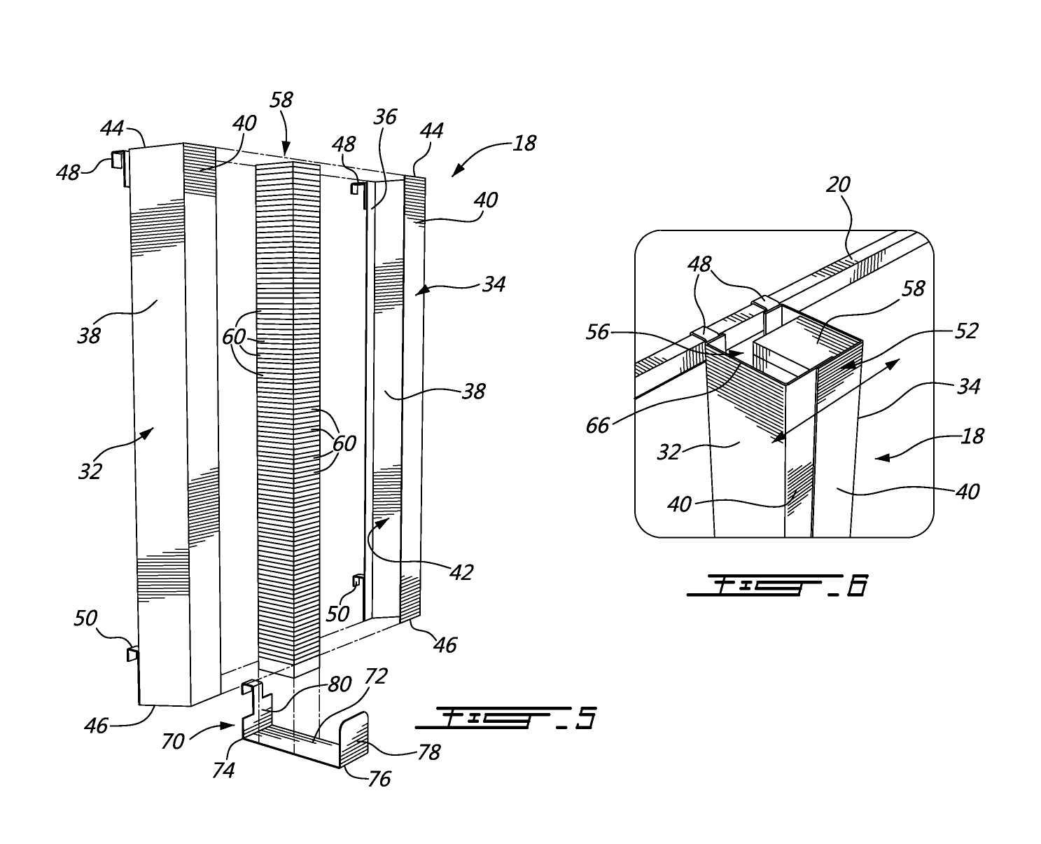

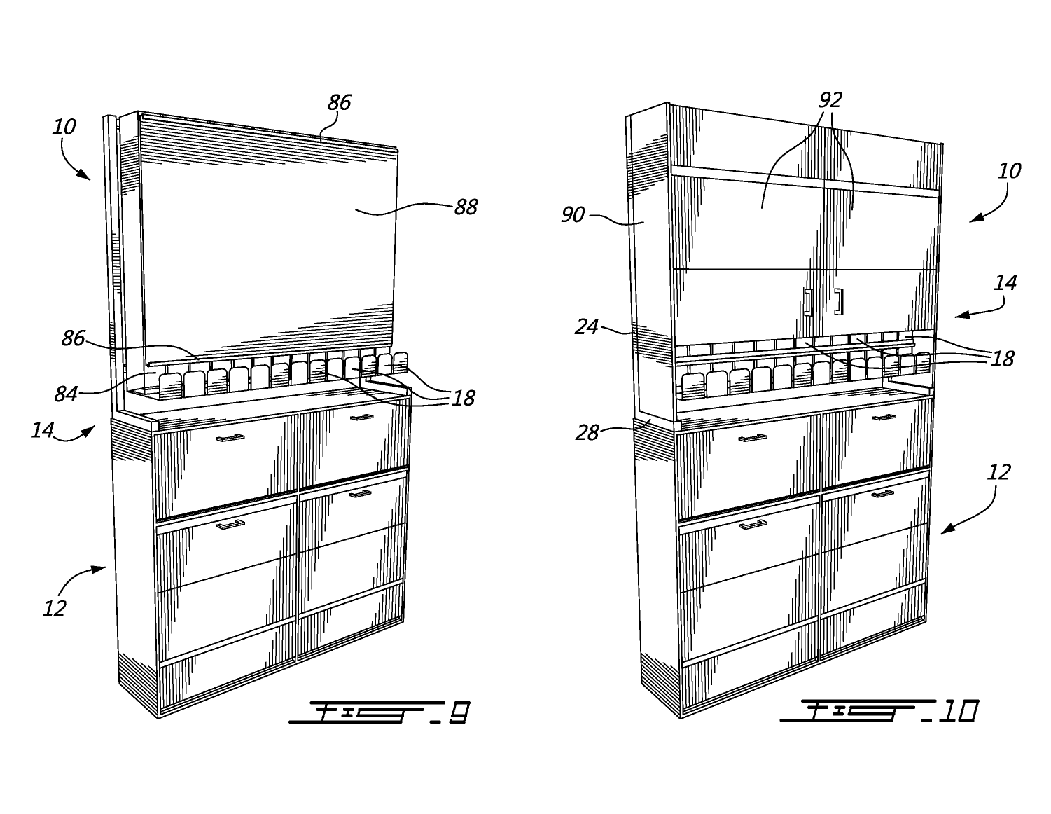

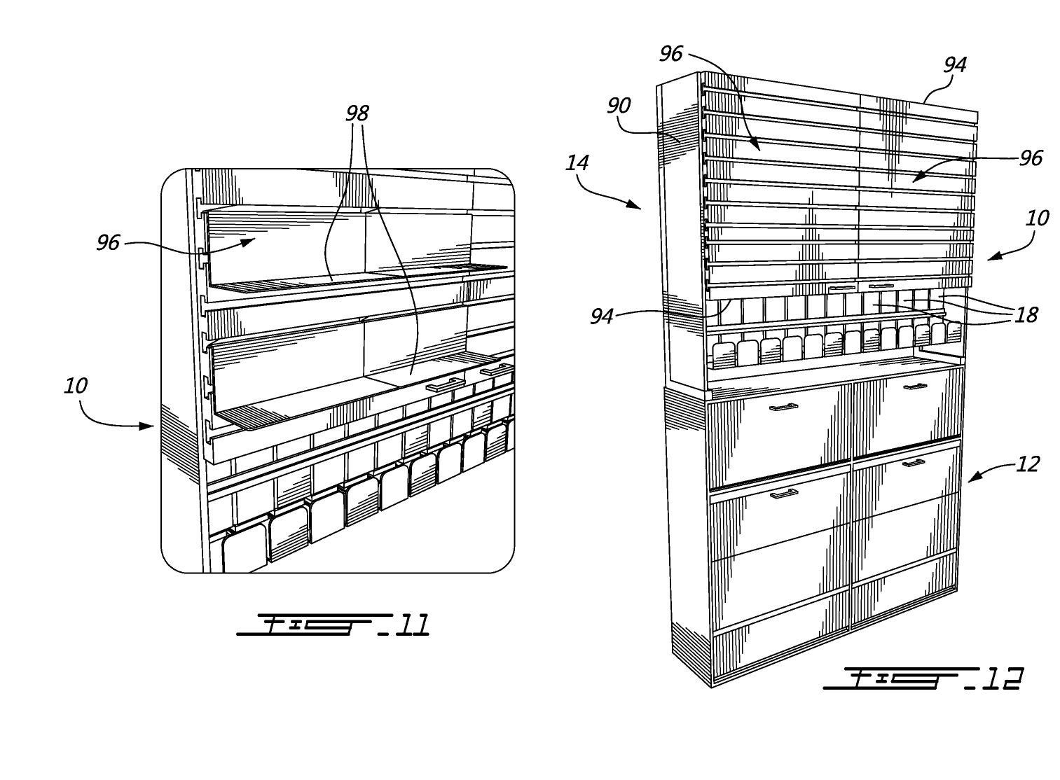

The top end 66 (see FIGS. 4, 6 and 7C) of the vertical dispenser column 18 is open and has a generally flat configuration. The bottom end 68 (see FIGS. 4 and 8A-8C) of the vertical dispenser column 18 is also open but has an upwardly sloped configuration defining an out-feed or outlet with an extended tongue member 70 mounted thereto.

Turning back to FIG. 5, the tongue member 70 includes a flat rectangular platform 72 having front and rear ends 74 and 76 respectively. An upward flap 78 extends from the front end 74; an upward extension wall 80 extends from the rear end 76 and includes a hook member 82. This hook member extends outwardly of the longitudinal slot 54 and is mounted directly on the bottom rail 22.

As shown in FIGS. 8A, 8B and 8C, the bottom tongue 70 extends forwardly beyond the common front wall 52 of the vertical dispenser column 18 and provides a space for reaching for a packet 60 that is accessible via the opening (outlet or out-feed) 68 so as to be pulled therefrom. Once a packet 60 is pulled, the next adjacent upper packet falls onto the rectangular platform 72 and can be accessed. The front flap 78 avoids the packet 60 from falling off the platform 72 without being manually lifeted.

Turning back to FIGS. 7A, 7B and 7C when the first and second longitudinal elements 32 and 34 are assembled one of the two overlapping element 32 or 34 will necessarily be the front element and the other will be the rear element. In the illustrated example, the second element 34 is the front element since its front wall 40 overlaps the front wall 40 of the first or rear element 32. As such, the narrow back wall 36 of the first longitudinal element 32 (the rear element) is closer to the railings 20 and 22 than the narrow back wall 36 of the second longitudinal element 34 (the front element). Therefore, the top and bottom hook members 48 and 50 of second element 34 have to be moved towards the rails 20 and 22 in order to grip them; this causes a tension force in the second element 34 which is consequently applied onto the first element 32 thus providing a more tight and stable assembly 18 between the two elements 32 and 34. It is therefore advantageous to use materials for the first and second elements 32 and 34 that provide this spring type resilience.

The narrow back walls 36 of both the first and second elements 32 and 34 flushingly engage the rear extension wall 80 of the tongue member 70 since the latter is positioned closer to the rails 20 and 22 than elements 32 and 34. Alternatively, the rear extension wall 80 flushingly engages the narrow back walls 36 causing a greater distance between the hook member 82 of the tongue member 70 resulting in tension caused between the rear wall extension 80 and the bottom rail 22 which is consequently applied onto the narrow back walls 36 securing the vertical dispenser column 18 on the rail 22.

Returning to FIG. 1, the dispenser assembly 10 is formed by a plurality vertical dispenser columns 18 positioned side by side along the rails 20 and 22 thereby defining a front face 84, the width of which can be modified by adding or removing vertical dispenser columns 18. The front face 84 includes mounting elements 86.

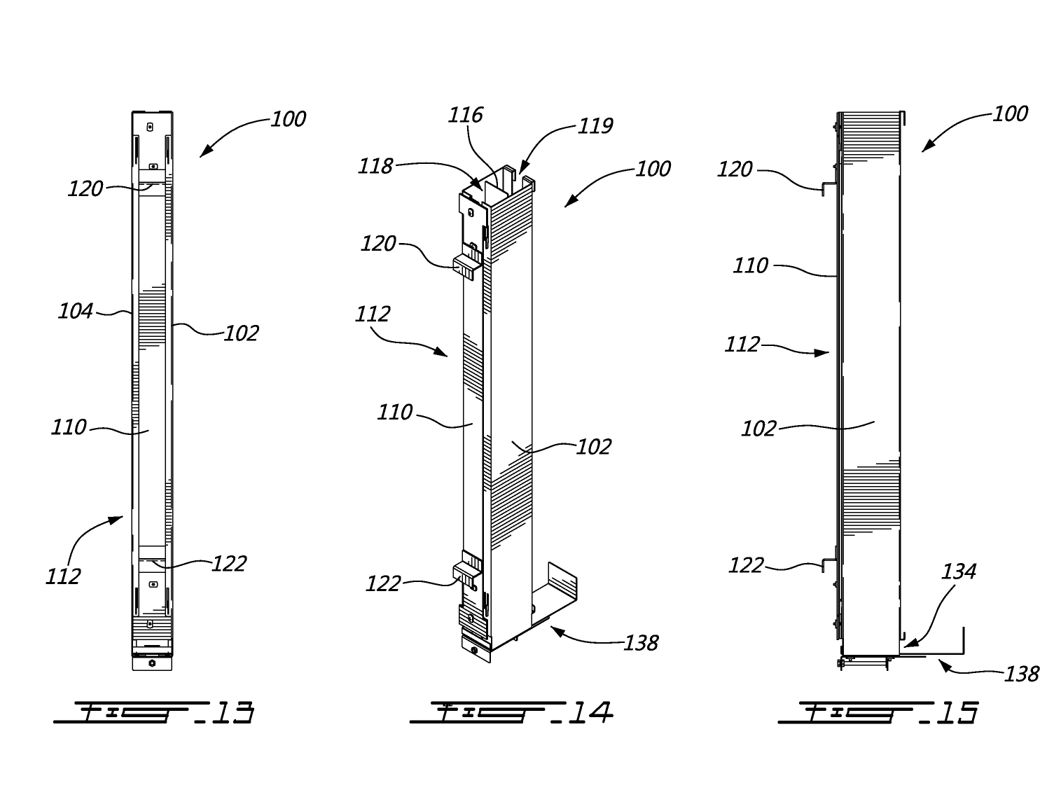

As shown in FIG. 9, an LCD screen 88 be mounted onto top and bottom horizontal mounting elements 86 securing the screen 88 to the front face 84 of the dispenser assembly 10.

In another example shown in FIG. 10, side panels 90 are mounted onto the posts 24 and 26 and base members 28 in order to hingebly connect front doors 92 thereon which cover the front face 84.

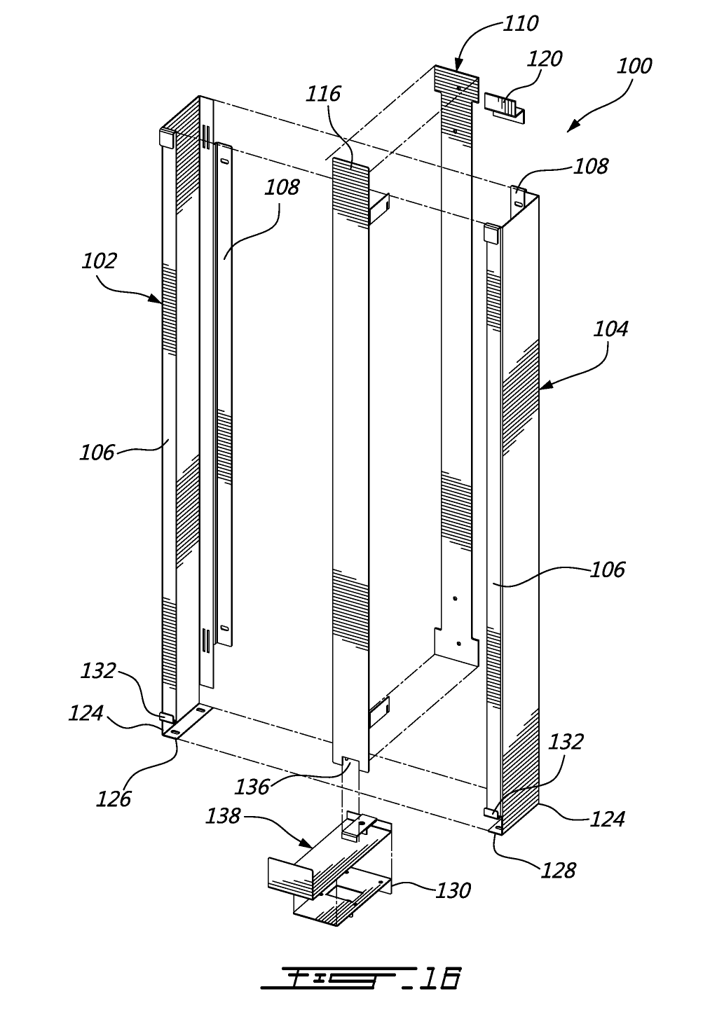

In another example shown in FIGS. 11 and 12, the front doors 94 are provided with slat walls 96 in order to receive various accessory supports 98.

Of course, a variety of other type of configurations can be provided within this cope of the present invention.

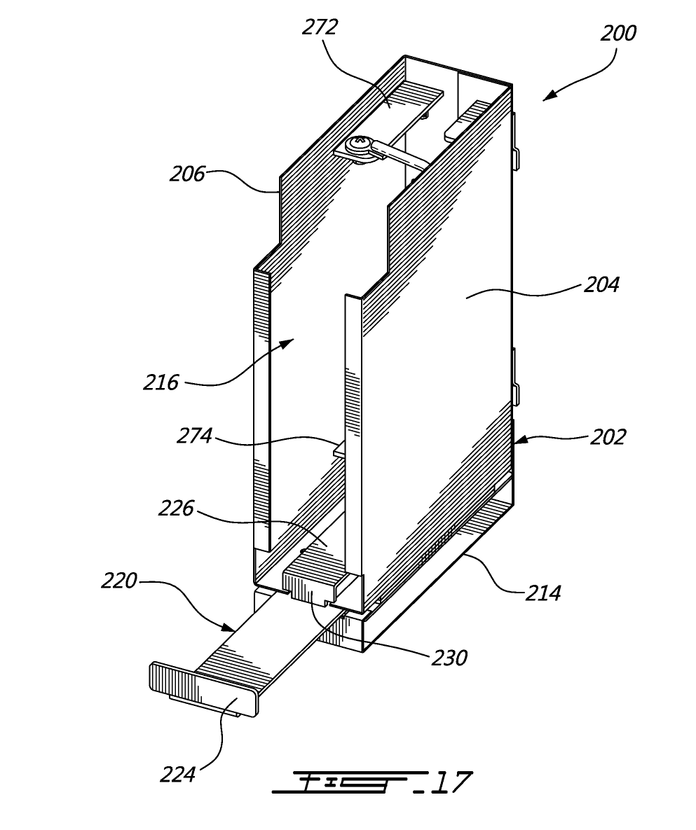

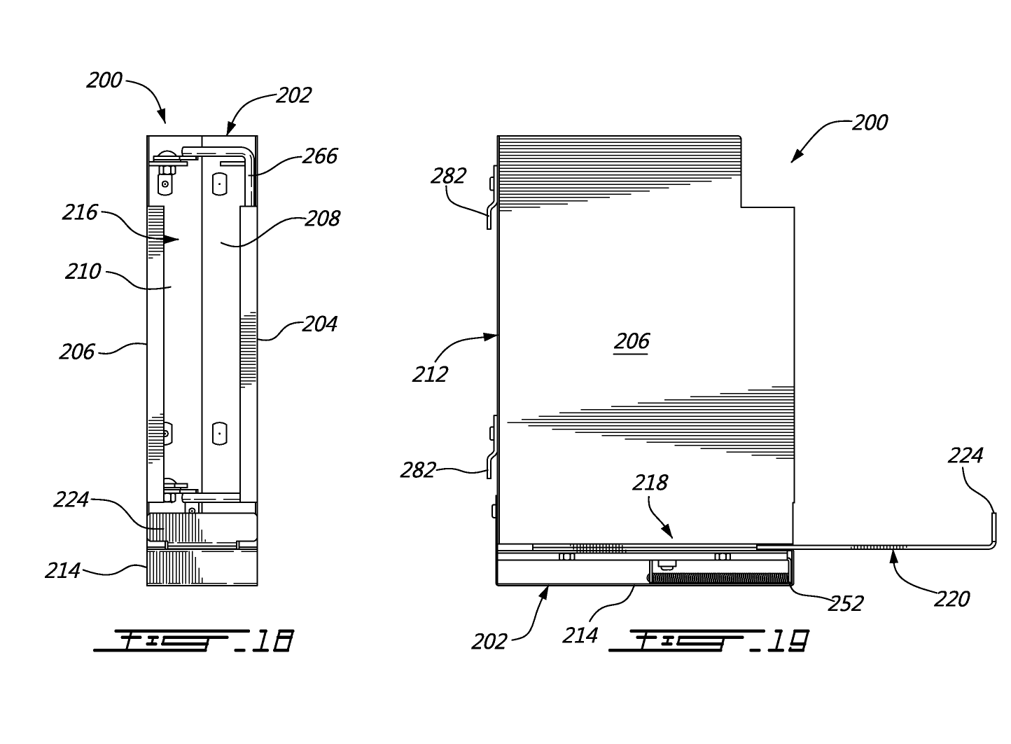

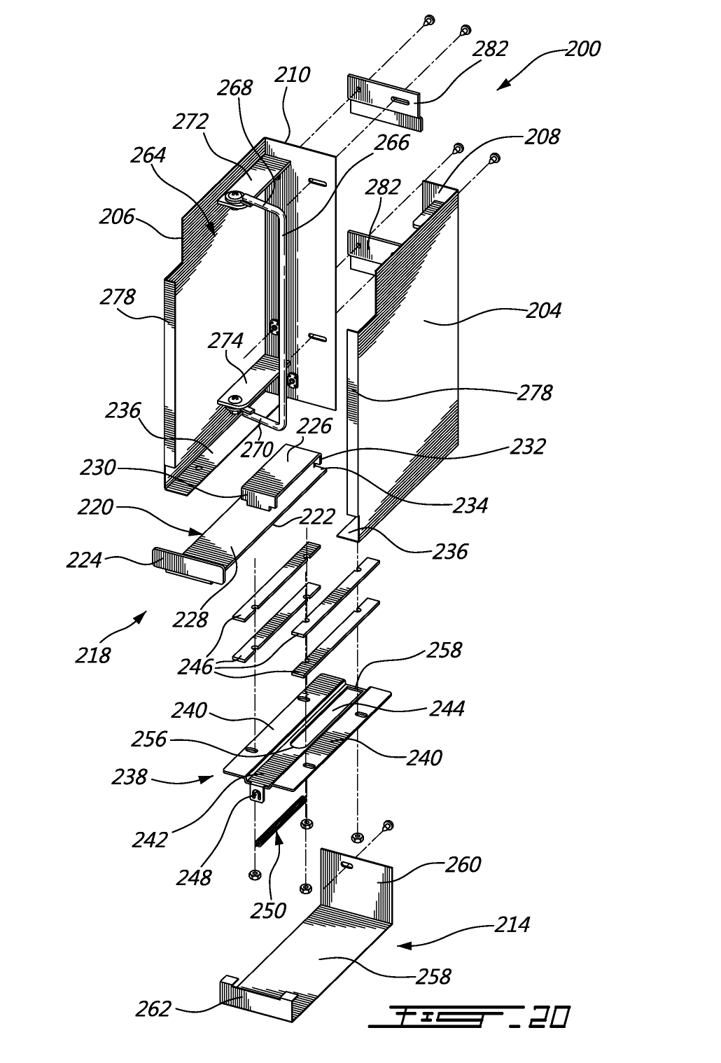

Turning now to FIGS. 13 to 16, another illustrative embodiment of the vertical dispenser column 100 will now be described.

The vertical dispenser column 100 is made out of a pair of lateral longitudinal walls 102 and 104, each having respective front and rear flanges 106 and 108 respectively. The rear flanges 108 of the lateral walls 102 and 104 are fixedly secured on a longitudinal back strip 110 defining the rear side 112 of the vertical dispenser column 100. The front flanges 106 of the lateral walls 102 and 104 define a longitudinal front slot 114. An auxiliary longitudinal strip 116 is fitted between the lateral walls 102 and 104. The auxiliary strip 116 and the back strip 110 along with the lateral walls 102 and 104 define a longitudinal channel 118 therebetween for receiving a plurality of stacked packets such as cigarettes, for example.

Top and bottom hook elements, 120 and 122 respectively are mounted to the back strip 110 in order to mount the vertical dispenser column 100 to top and bottom rails 20 and 22, respectively, as described hereinabove.

The bottom ends 124 of the lateral walls 102 and 104 include inwardly directed bottom flanges 126 and 128 which are fixedly mounted to a bottom support element 130. The respective front flanges 106 of the lateral walls 102 and 104 have respective bottom ends 132 that are spaced apart from the respective bottom flanges 126 and 128; thus, when the vertical dispenser column 100 is assembled, the foregoing configuration provides a front opening 134 which acts as an outlet or out-feed.

The bottom end 136 of the auxiliary strip 116 is mounted to a tongue member 138 having a front flap 140 and rear mounting end 142 mounted to the auxiliary strip 116. The auxiliary strip 116 includes spacers 144 in order to abut and be spaced away from the backing strip 110. The tongue member 138 is slidably mounted onto the bottom support element 130 in order to be forwardly and rearwardly movable between the front flanges 106 and the backing strip 110 thereby enlarging or reducing the size of the longitudinal channel 118 defined by the vertical dispenser column 100.

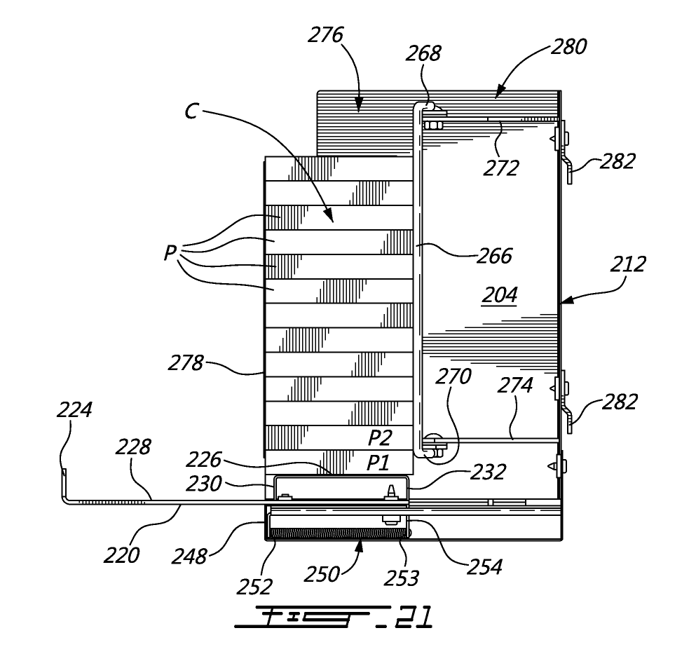

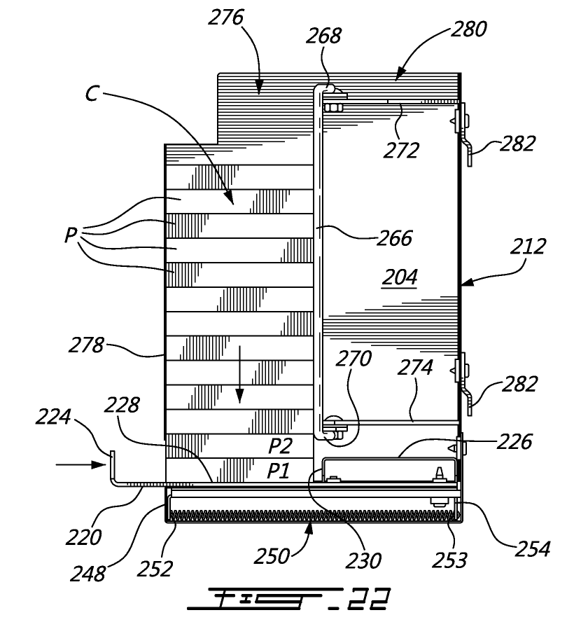

FIGS. 17 through 23 show a further embodiment of a vertical dispenser column 200.

The vertical dispenser column 200 comprises a housing 202 having a pair of side panels 204 and 206 respectively including backing portions 208 and 210 which are mounted together to form the common back wall 212. The backing portion 208 and 210 can be adjusted when mounted together in order to adjust the width of the housing 202. An L-shaped base element 214 is mounted to the back wall 212. The housing 202 also includes an open front face 216.

The dispenser column 200 also includes a pushing-mechanism assembly 218.

The pushing-mechanism assembly 218 includes a push member 220 including an elongated rectangular body 222 defining a platform with a front lower level portion 228 thereof and an adjacent rear upper level portion 226. The platform 222 includes a front engaging element 224 upwardly extending from the lower level portion 228. A short backing element 230 defines the rear end of the lower level platform portion 228 and acts as a spacer along with corresponding element 232 at the back end 234 of the platform 222 for upwardly spacing and supporting the upper level platform portion 226.

The side panels 204 and 206 include respective lower inwardly protruding flanges 236 which rest on the platform 222.

The pushing mechanism assembly 218 also includes a guide element 238. The guide element 238 includes a pair of side wings 240 flanking a guiding strip 242 there between. The guiding strip 242 includes a guiding slot 244. The side wings 240 are mounted to the flanges 236 with the assistance of support strips 246. The guiding strip 243 includes a front tongue element 248 for supporting a deformable and resilient element 250, in this example being provided in the form of a spring element. As such, the spring 250 is supported at its front end 252 by the tongue element 248 and at its rear end 253 by a tab 254 downwardly extending from the short backing 232 through the guiding slot 244. More specifically, the guiding slot 244 provides for the tab 254 to slide from the front end 256 to the rear end 258 thereof.

The base element 214 includes a floor 258, a back wall 260 for being mounted to the rear wall 212 as well as a front strip 262 having a pair of short tabs 262 which are mounted to the side wings 240.

The vertical dispenser column 200 also includes a length adjustment assembly 264 including a pivotable rod 266 being pivotally mounted via top and bottom finger members 268 and 270 respectively to top and bottom support members 272 and 274 respectively. The support member 272 and 274 are extending from the back wall portion 210 and the side panel 206. The rod 266 acts as a vertical stack backing thereby containing the vertical stack of packets P in place.

As such, the pivoting rod 266 provides for adjusting the length of the receiving area 274 which receives a plurality of small packets P, being in the form of cigarette containers. The packets P are kept in place between front inwardly protruding strips 278 extending from the side panels 204 and 206 and the adjustable pivotable rod 266.

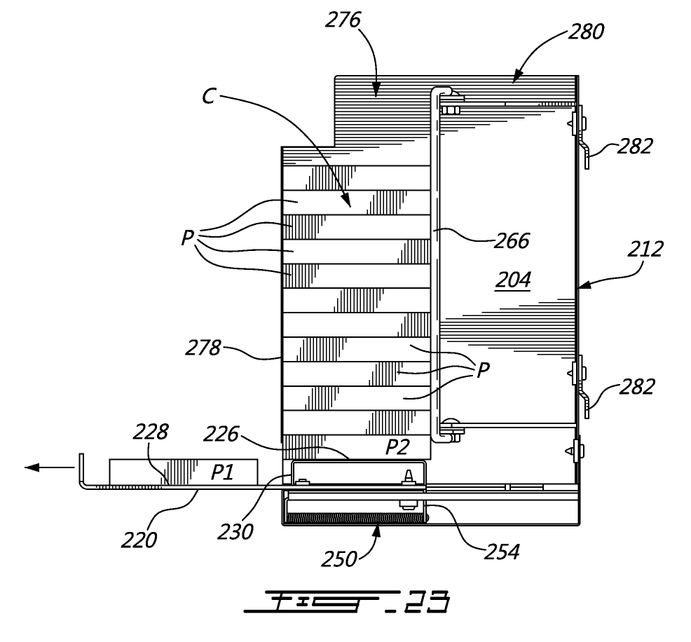

As shown in FIG. 21, the packets P are upstanding from the upper level platform 226 as they rest thereon. When the user wishes to retrieve a packet P, the user inwardly pushes the platform 222 by applying force on the front engaging element 224 as shown in FIG. 22. As such, the tab 254 slides along slot 244 from the front end 258 to the back end 254 thereof stretching out the spring element 246. The upper level platform portion 226 is therefore displaced from the front area 276 to a rear area 278 that is behind the rod 266. As such, the packets P fall on to the platform 224. When the user releases the force their applying on the engaging element 224, the resiliency of the spring 250 pulls the tab 254 from the rear end 258 of slot 244 towards the front end 256 thereof thereby moving the upper level at form 226 back into area 276 and moving the lower level platform 228 exterior of the housing 202 including the lower most packet P-1 of a column C of packets.

The next two lower packet P-2 which rested on the packet P-1 along with the column C of packets is maintained within the area 274 by the strips 278 which act as stoppers and as P-1 slides away from packet P-2 while being pushed by backing 230, the upper platform portion 226 slides thereunder to upwardly support packet P-2 as well as the column C.

The back wall also includes hook elements 282 to be mounted to railings as previously explained.

The various features described hereinabove can be combined in a variety of suitable ways, as the skilled artisan will readily appreciate, so as to provide further embodiments within the spirit, scope and nature of the present disclosure. Furthermore, it is to be understood that the invention is not limited in its application to the details of construction and parts illustrated in the accompanying drawings and described hereinabove. The invention is capable of other embodiments and of being practiced in various ways. It is also to be understood that the phraseology or terminology used herein is for the purpose of description and not limitation. Hence, although the invention has been described and exemplified hereinabove by way of embodiments thereof, it can be modified, without departing from the spirit, scope and nature of the appended claims.

What is claimed is:

1. A dispenser for packets comprising:
a housing defining a channel for receiving a vertical stack of packets and having an outlet opening in communication with said channel; and
a platform comprising lower and upper level portions thereof and being movably mounted to said housing through said outlet opening so as to be movable between an outward position, wherein said lower level portion is positioned outwardly of said housing and said upper level portion is positioned in said channel, and an inward position, wherein said lower and upper level portions are positioned in said channel,
wherein when said platform is in said outward position the vertical stack rests on said upper level portion, when said platform is moved to said inward position, the vertical stack drops on said lower level portion and when said platform is returned to said outward position, said lower level portion moves the lowermost packet of the vertical stack outwardly of said housing therewith through said outlet opening.

2. A dispenser according to claim 1, wherein said platform is biased to said outward position.

3. A dispenser according to claim 2, wherein said platform is outwardly biased by a deformable and resilient member mounted to the housing.

4. A dispenser according to claim 1, wherein said channel is a vertical channel.

5. A dispenser according to claim 4, wherein said housing further comprises a pair of side panels defining said vertical channel.

6. A dispenser according to claim 1, wherein said housing comprises a front wall, said outlet opening formed in said front wall.

7. A dispenser according to claim 1, wherein said housing comprises an open front face having front strips for maintaining the vertical stack of packets in place within said channel.

8. A dispenser according to claim 1, wherein said channel comprises a front area for receiving the vertical stack of packets and an adjacent rear area, wherein when said platform is in said outward position said upper lever portion is positioned in said front area, and wherein when said platform is in said inward position, said lower level portion is positioned in said front area and said upper level portion is positioned in said rear area.

9. A dispenser according to claim 1, wherein said platform further comprises a backing element between said lower and upper level portions for pushing the lowermost packet outwardly with said lower level portion.

10. A dispenser according to claim 1, wherein housing provides for modifying the size of said channel.

11. A dispenser according to claim 1, wherein said housing comprises front and rear sides as well as lateral sides for defining said channel.

12. A dispenser according to claim 11, wherein said housing rear side comprises a wall.

13. A dispenser according to claim 11, wherein said rear side comprises a backing for maintaining the vertical stack of packets in place in said channel.

14. A dispenser according to claim 13, wherein said backing is movable so as to modify the length of said channel.

15. A dispenser according to claim 14, wherein said movable backing comprises a rod pivotally mounted to said housing.

16. A dispenser according to claim 11, wherein said lateral sides are movable with respect to each other so as to modify the width of said channel.

17. A dispenser assembly comprising a plurality of side by side dispensers, wherein it least one of said plurality is a dispenser according to claim 1.

18. A dispenser comprising:
a housing defining a vertical channel defining a vertical receiving area thereof for receiving a vertical stack of similar sized packets and having an outlet opening in communication with said channel; and
a vertical adjustment member movably mounted to said housing within said channel for adjusting the size of said receiving area,
wherein the size of said receiving area is adjusted in accordance with the size of the packets in the vertical stack.

19. A dispenser according to claim 18, wherein said vertical adjustment member comprises a rod.

20. A dispenser according to claim 18, wherein said housing comprises an inner peripheral wall surface defining said channel, said vertical adjustment member being movably mounted to said internal peripheral wall surface.

21. A dispenser assembly comprising a plurality of side by side dispensers, wherein it least one of said plurality is a dispenser according to claim 18.

22. A dispenser comprising:
a housing comprising
at least two wall members defining a vertical channel for receiving a vertical stack of packets therein; and
an outlet opening in communication with said channel,
wherein at least one of said wall members is movable so as to modify the width of the channel.

23. A dispenser according to claim 22, wherein said vertical wall members comprise portions thereof forming a front face, said width of said front face being modifiable when moving said at least on wall member.

24. A dispenser assembly comprising a plurality of side by side dispensers, wherein it least one of said plurality is a dispenser according to claim 22.

25. A dispenser assembly comprising:
a plurality of separate side by side vertical dispenser columns defining a common front face comprising mounting elements thereof for receiving a display, each said vertical dispenser column comprising defining a vertical channel for receiving a vertical stack of packets therein and an outlet opening communication with said channel,
wherein the width of said front face is modifiable by adding or removing one or more of said vertical dispenser columns in accordance with the width of the display.
